(19) United States
(12) Patent Application Publication
(10) Pub. No.: US 2025/0155933 A1
(43) Pub. Date: May 15, 2025

(54) MOBILE DEVICE PROTECTION AND SUPPORT FRAME

(71) Applicant: SHENZHEN MOFT TECHNOLOGY CO., LTD., Shenzhen (CN)

(72) Inventor: BEN-TIEN LIN, NEW TAIPEI CITY (TW)

(21) Appl. No.: 19/026,539

(22) Filed: Jan. 17, 2025

Related U.S. Application Data
(63) Continuation of application No. PCT/CN2023/107819, filed on Jul. 18, 2023.

(30) Foreign Application Priority Data
Aug. 3, 2022 (CN) 202222040981.5

(51) Int. Cl. G06F 1/16

(52) U.S. Cl. CPC G06F 1/166; G06F 1/1626

(57) ABSTRACT

A mobile device protection and support frame, which can be coupled to a mobile device by a coupling mechanism, includes: a first part having a fixed part arranged on a side of the first part, when the mobile device protection and support frame is coupled to the mobile device, the fixed part cannot be moved or folded relative to the mobile device; and a second part, connected to the first part by a first primary flexible part. The first part further includes a second primary flexible part spanning across the first part and disposed adjacent to the fixed part, so that a part of the first part and the second part can be folded relative to the fixed part. The second part further includes a third primary flexible part substantially parallel to the second primary flexible part. The first part is a sheet body having two sides, and a first free end of the second part can be folded towards either of the two sides of the first part by the second primary flexible part or the third primary flexible part to abut against the first part.

### CROSS-REFERENCE TO RELATED APPLICATION(S)

The present disclosure is a continuation application of International application No. PCT/CN2023/107819, filed on Jul. 18, 2023, which claims priority to Chinese Patent Application No. 202222040981.5, filed on Aug. 3, 2022, the disclosure of which are incorporated herein by reference in their entireties.

### TECHNICAL FIELD OF THE DISCLOSURE

The present disclosure relates to the field of storage frames, and more particularly relates to a support frame which can protect the casing of a mobile device, and can present a variety of upright positions after the support frame is folded and unfolded, so as to facilitate the mobile device to stand upright.

### DESCRIPTION OF RELATED ART

In recent years, with the advancement of mobile communication technology, various kinds of mobile devices, such as mobile phones, tablet PCs or laptops, have become indispensable and commonly used in daily life. However, the mobile devices are often used for watching movies, searching for information, or operating social networking sites, etc., and most of them need to be viewed or manipulated in a hand-held manner, which leads to tremendous inconvenience.

In general, when holding a mobile device with one hand, users can only use the other hand to control and operate the mobile device, especially for larger mobile devices such as tablet PCs, which are inconvenient to use and restrict the user's hands. Therefore, if the mobile device can be placed flat on a flat surface such as a table when the user is using the mobile device indoors, then the user can use it with both hands free. However, in this case, the mobile device can only be placed flat on a table, making it difficult for the user to see the contents of the screen or to control the screen from an angle that is inconvenient for the users to operate. Obviously, it is still inconvenient and needs to be improved.

In view of this, the discloser of the present disclosure based on years of experience in the related industry to conceptualize and propose a folding mobile device support structure to overcome the deficiency of the existing way of use.

### SUMMARY OF THE DISCLOSURE

The present disclosure relates to a mobile device protection and support frame, which can be coupled to a mobile device by a coupling mechanism, and the mobile device protection and support frame includes: a first part, including a fixed part arranged on a side of the first part, such that when the mobile device protection and support frame is connected to the mobile device, the fixed part cannot be moved or folded relative to the mobile device; and a second part connected to the first part by a first primary flexible part. The first part further includes a second primary flexible part spanning across the first part and disposed adjacent to the fixed part, such that a part of the first part and the second part can be folded relative to the fixed part. The first part is a sheet body including two sides, and a first free end of the second part can be folded towards either of the two sides of the first part by the second primary flexible part or the third primary flexible part to abut against the first part.

In some embodiments, the second part further includes a third primary flexible part substantially parallel to the second primary flexible part. The second part includes a gap spanning across the first primary flexible part and the second primary flexible part, such that the first primary flexible part and the second primary flexible part are in a discontinuous form and disconnected to form a second free end and a third free end.

In some embodiments, the second part further includes a first secondary flexible part and a second secondary flexible part, respectively and symmetrically arranged on two sides of the gap. The second free end and the third free end can be folded towards either of the two sides of the first part by the first secondary flexible part and the second secondary flexible part. The first secondary flexible part and the second secondary flexible part span across the first primary flexible part and the third primary flexible part.

In some embodiments, the first free end can be folded towards either of the two sides of the first part by the second primary flexible part or the third primary flexible part to abut against the second primary flexible part.

In some embodiments, after the mobile device protection and support frame is coupled to the mobile device, a side of the mobile device can be folded by the first primary flexible part and the second primary flexible part to abut against the second part; or after the mobile device protection and support frame is coupled to the mobile device, a side of the mobile device can be folded towards either of the two sides of the first part by the second primary flexible part.

In some embodiments, the mobile device protection and support frame further includes a distal part located between the third primary flexible part and the first free end, and a part of the second free end and the third free end can be folded towards the distal part by the first secondary flexible part and the second secondary flexible part and attached.

In some embodiments, the coupling mechanism is a bottom plate, and the fixed part is coupled to a part of the bottom plate, such that the first part and the second part can be folded relative to the bottom plate by the first primary flexible part, the second primary flexible part or the third primary flexible part. The bottom plate is ferromagnetic, such that a part of the bottom plate can be coupled to the fixed part or the mobile device. In some embodiments, the fixed part and a part of the bottom plate are fixed to each other, such that the first part and the second part can be folded relative to the bottom plate by the second primary flexible part.

In some embodiments, the coupling mechanism is a snap-on back cover with a size substantially the same as the mobile device and snapped to a side of the mobile device, and the fixed part is coupled to a part of the snap-on back cover, such that the first part and the second part can be folded relative to the snap-on back cover by the first primary flexible part, the second primary flexible part or the third primary flexible part. The snap-on back cover is ferromagnetic, such that a part of the snap-on back cover can be coupled to the fixed part or the mobile device.

In some embodiments, the first free end can be abutted between the bottom plate and the first part or between the snap-on back cover and the first part by the first primary flexible part or the third primary flexible part; or after the mobile device protection and support frame is coupled to the mobile device, the bottom plate or the snap-on back cover or the first part and the second part can be attached to two sides of the mobile device respectively at the same time.

The mobile device protection and support frame of the present disclosure can be easily and conveniently used by users after folding, so that the frame can be placed according to the angle or direction required by the users for viewing or operating, thus greatly enhancing the convenience of use. Further, the present disclosure can be folded when not in use for convenient carry and storage.

### BRIEF DESCRIPTION OF THE DRAWING

FIG. 1 is a front view of an embodiment of the present disclosure;

FIG. 2 is a side view of an embodiment of the present disclosure;

FIG. 3 is another side view of an embodiment of the present disclosure;

FIG. 4A is a schematic view showing a first folding method in accordance with an embodiment of the present disclosure;

FIG. 4B is a schematic view showing the first folding method in accordance with an embodiment of the present disclosure;

FIG. 5 is a schematic view showing the first folding method on another side in accordance with an embodiment of the present disclosure;

FIG. 6 is a schematic view showing a second folding method in accordance with an embodiment of the present disclosure;

FIG. 7A is a schematic view showing a third folding method in accordance with an embodiment of the present disclosure;

FIG. 7B, is a schematic view showing the third folding method in accordance with an embodiment of the present disclosure, in another way of placement;

FIG. 8 is a schematic view showing a fourth folding method in accordance with an embodiment of the present disclosure;

FIG. 9 is another side view of an embodiment of the present disclosure, indicating a bending direction of a second free end and a third free end;

FIG. 10 is a further side view of an embodiment of the present disclosure, indicating another bending direction of the second free end and the third free end;

FIG. 11A is a schematic view showing a fifth folding method in accordance with an embodiment of the present disclosure;

FIG. 11B is a schematic view showing the fifth folding method on another side in accordance with an embodiment of the present disclosure;

FIG. 12A is a schematic view showing a sixth folding method in accordance with an embodiment of the present disclosure;

FIG. 12B is a schematic view showing the sixth folding method on another side in accordance with an embodiment of the present disclosure;

FIG. 12C is a schematic view showing a seventh folding method in accordance with an embodiment of the present disclosure;

FIG. 13A is a schematic view of a bottom plate of an embodiment of the present disclosure;

FIG. 13B is a schematic view showing the use of the bottom plate of an embodiment of the present disclosure;

FIG. 14 is a perspective view of an embodiment of the present disclosure and the bottom plate;

FIG. 15 is a perspective view showing a mobile device protection and support frame of the present disclosure coupled to the bottom plate;

FIG. 16 shows one of the using statuses of the present disclosure with the bottom plate;

FIG. 17 shows one of the using statuses of the present disclosure with the bottom plate;

FIG. 18 is a schematic view of a snap-on back cover of an embodiment of the present disclosure; and

FIG. 19 shows one of the using statuses of the present disclosure with the snap-on back cover.

### DETAILED DESCRIPTION OF THE DISCLOSURE

The non-permanent fixing method described in the present disclosure refers to fixing, connecting, joining, or interconnecting two objects by means of magnets, hook and loop tapes, removable snap mechanisms, or reusable adhesive tapes, etc., and the objects can be fixed, connected, joined, or interconnected at any time. The permanent fixing method described in the present disclosure refers to fixing, connecting, joining, or bonding two objects to each other by means of non-reinforced adhesive tapes, sewing, or stapling, etc.

The coupling described in the present disclosure refers to fixing, connecting, joining, or interconnecting two objects to each other by means of a non-permanent fixation or a permanent fixation as described above. The magnetic properties described in the present disclosure include permanent magnetic properties, non-permanent magnetic properties, or ferromagnetic properties.

Although the terms “first”, “second”, and “third” may be used herein to describe various components, parts, areas, or portions, these components, parts, areas, and/or portions should not be limited by the terms. The terms are used only to distinguish one component, part, area, or portion from another component, part, area or portion. Therefore, the term “first . . . ”, as used below, may be interpreted as “second . . . ” or “third . . . ” without departing from the teachings of this specification.

The flexible part as described in this specification is any structure that connects at least two sheet body structures and allows the sheet body structures to bend toward each other.

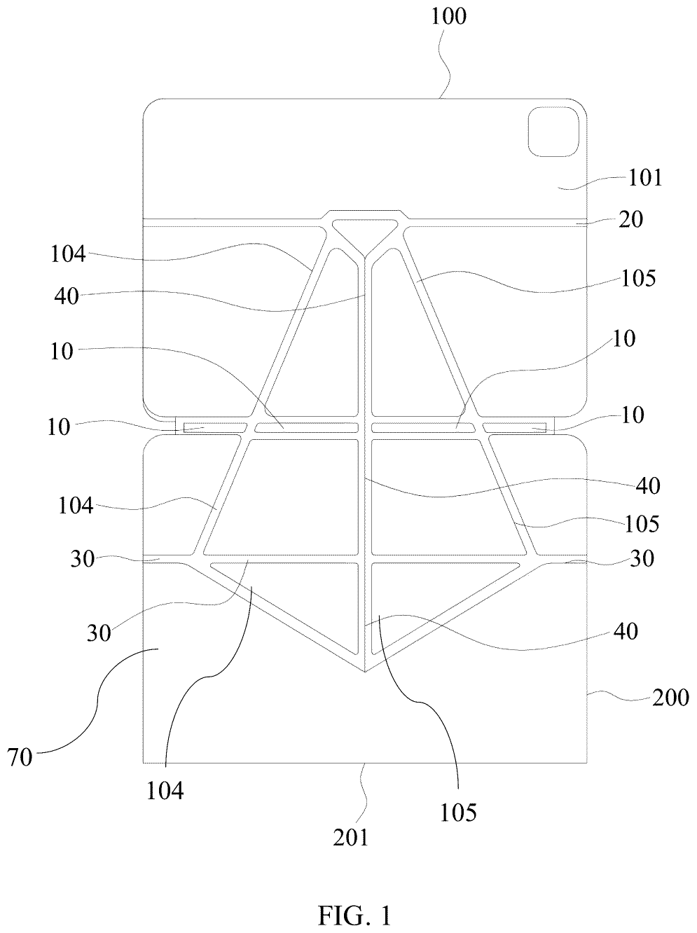

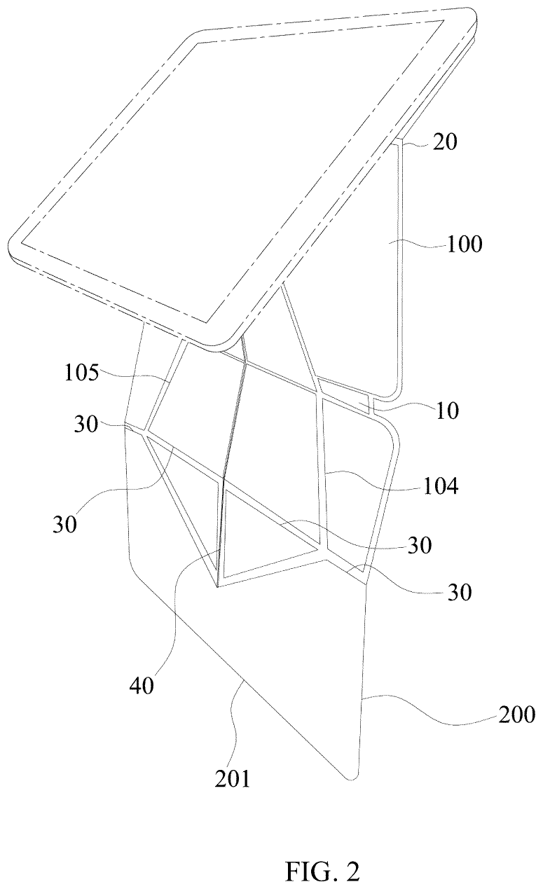

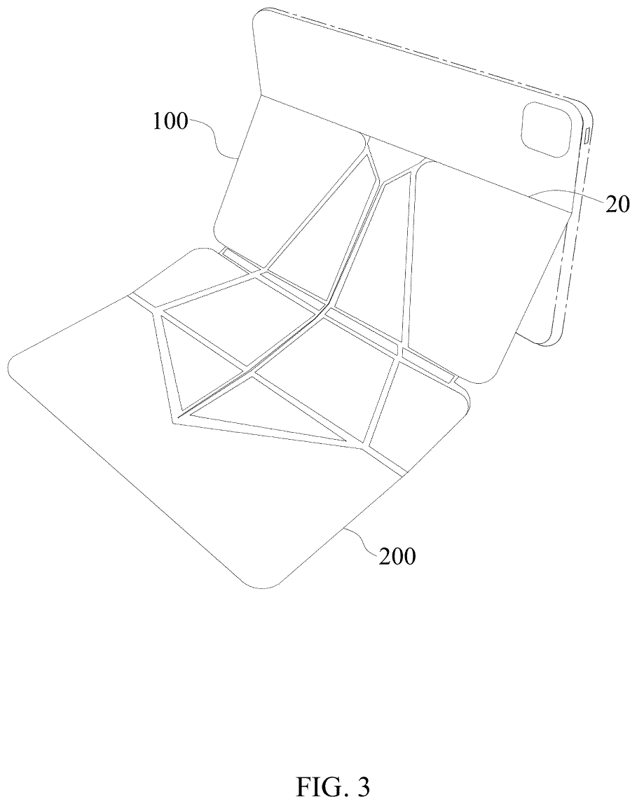

With reference to FIGS. 1 to 3 for a mobile device protection and support frame of the present disclosure, the mobile device protection and support frame can be coupled to a mobile device by a coupling mechanism. The mobile device protection and support frame is mainly a sheet body with a plurality of flexible parts, so that the sheet body can be folded by the flexible parts. The present disclosure includes a first part 100 and a second part 200. Both of the first part 100 and the second part 200 are sheet bodies having two sides. The first part includes a fixed part 101 located on a side of the fixed part 101. The fixed part 101 is used to directly or indirectly engage, connect, associate, or join with a mobile device in a permanently fixing or non-permanently fixing manner (collectively referred to as coupling). The term “directly” refers to the fixed part 101 which is directly coupled to a surface of the mobile device in a permanent or non-permanent manner; while the term “indirectly” refers to the fixed part 101 which is coupled to the mobile device through another medium (such as a bottom plate 50 or a cell phone backshell, etc.). However, whether it is directly or indirectly coupled to a mobile device, the fixed part 101 cannot be moved or folded relative to the mobile device. The fixed part 101 is like other parts of the first part 100 and a fulcrum for folding the second part 200. In the present disclosure, a first primary flexible part 10 is arranged between the first part 100 and the second part 200. The second part 200 is connected to the first part 100 by the first primary flexible part 10. The first part 100 further includes a second primary flexible part 20 spanning across the first part 100 and disposed adjacent to the fixed part 101, such that a part of the first part 100 and the second part 200 can be folded relative to the fixed part 101, as shown in FIG. 3.

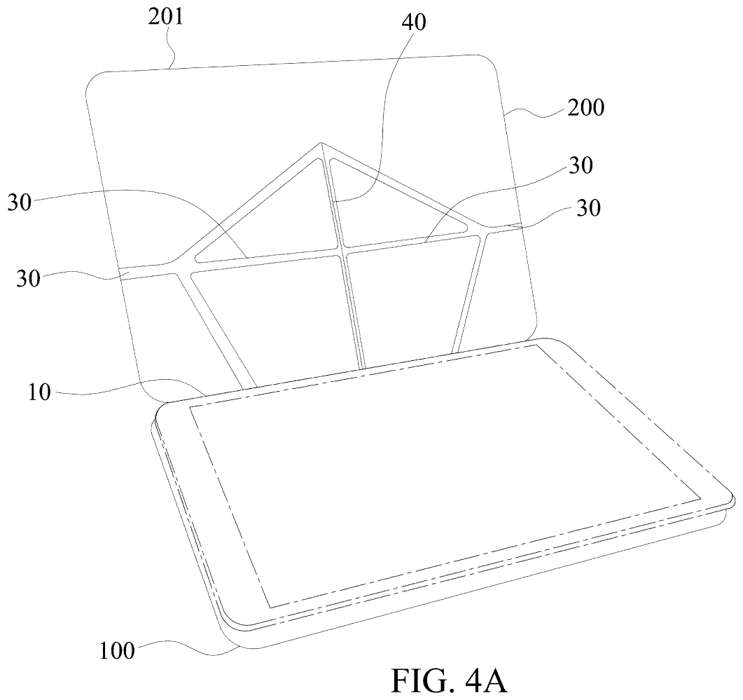

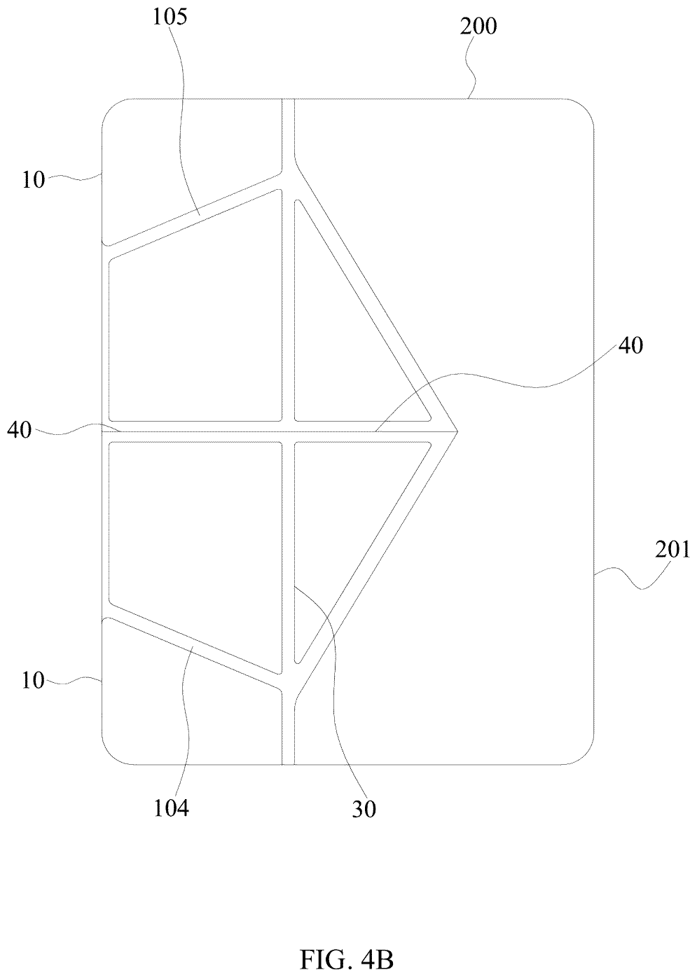

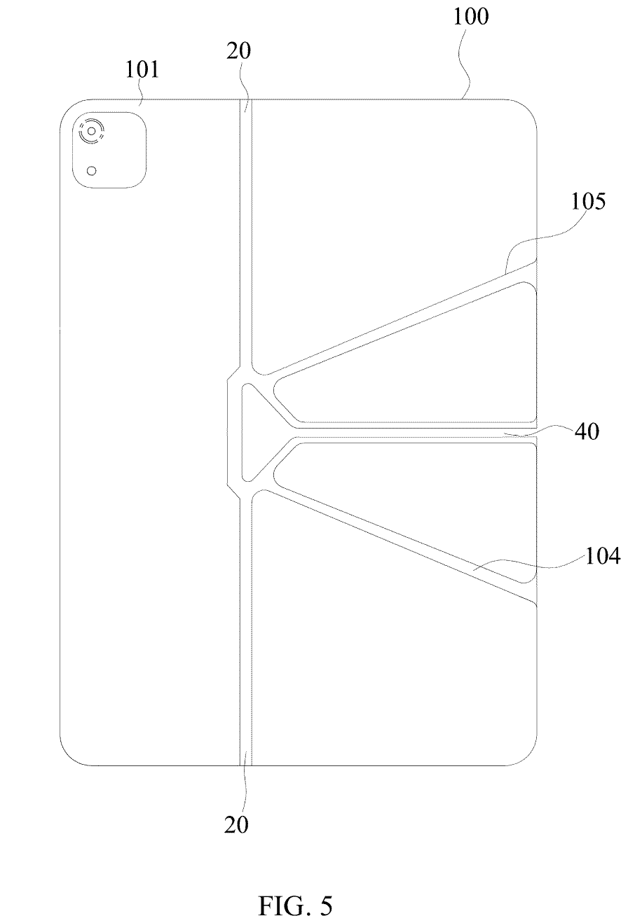

In FIGS. 4A, 4B and 5, the mobile device protection and support frame of the present disclosure can be folded by the first primary flexible part 10 to attach a side of the first part 100 and a side of the second part 200 with two sides of the mobile device respectively, so as to achieve the effect of protecting the exterior of the mobile device.

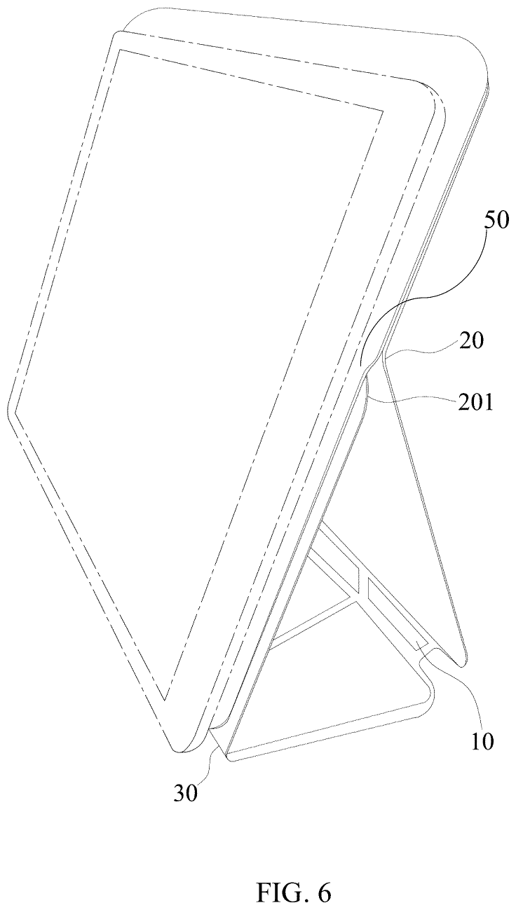

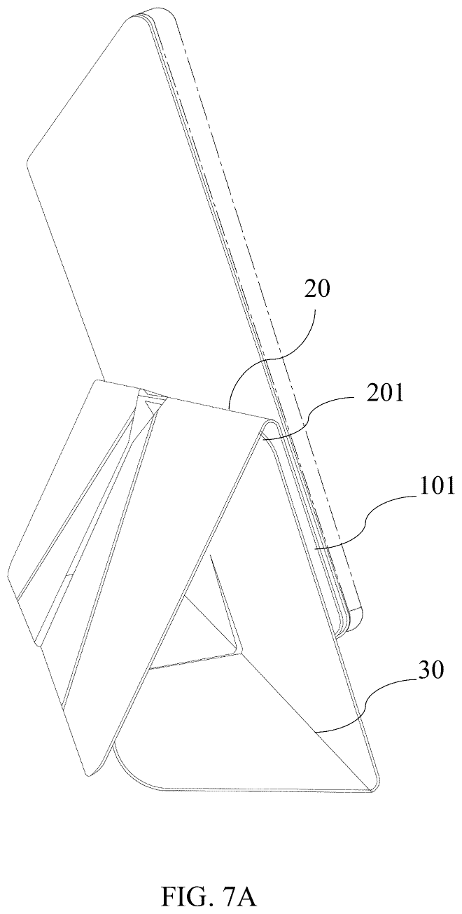

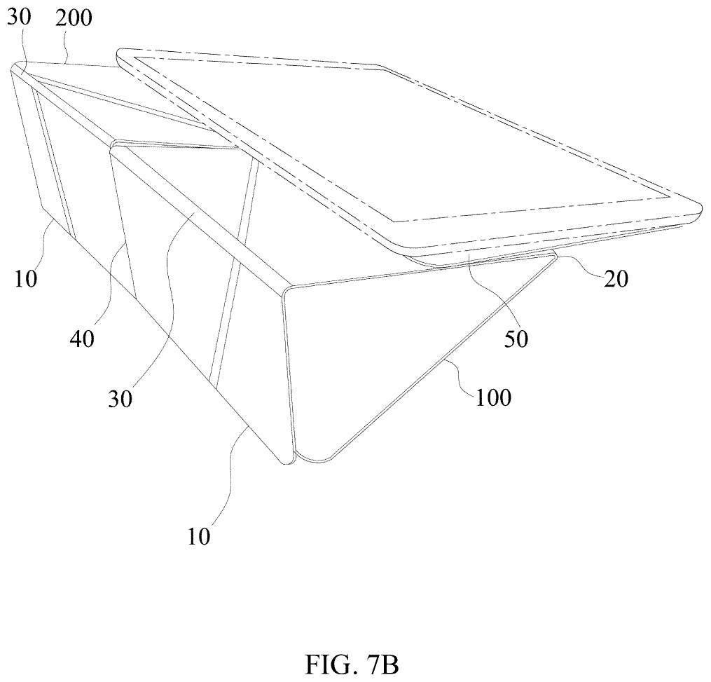

In FIGS. 1 to 3, in some embodiments, the second part 200 further includes a third primary flexible part 30 substantially parallel to the second primary flexible part 20. A first free end 201 of the second part 200 can be folded towards either of the two sides of the first part 100 by the second primary flexible part 20 or the third primary flexible part 30 to abut against the first part 100, and further define the folding status as shown in FIGS. 6 and 7A, 7B to support the mobile device which is coupled to the mobile device protection and support frame of the present disclosure.

Specifically, as shown in FIG. 6, the first free end 201 can be folded towards either of the two sides of the first part 100 by the second primary flexible part 20 or the third primary flexible part 30 to abut against the second primary flexible part 20, and define the support status as shown in FIG. 6. In another embodiment as shown in FIGS. 7A and 7B, the folding by the second primary flexible part 20 and the third primary flexible part 30 makes the fixed part 101 and a part of the second part 200 to be attached to define another support status. In other words, by this folding method, after the mobile device protection and support frame is coupled to the mobile device, a side of the mobile device can be folded to either of the two sides of the first part 100 by the second primary flexible part 20. The folding methods as shown in FIG. 7A and FIG. 7B are the same, the mobile device is placed on a flat surface at different angles to produce different support angles.

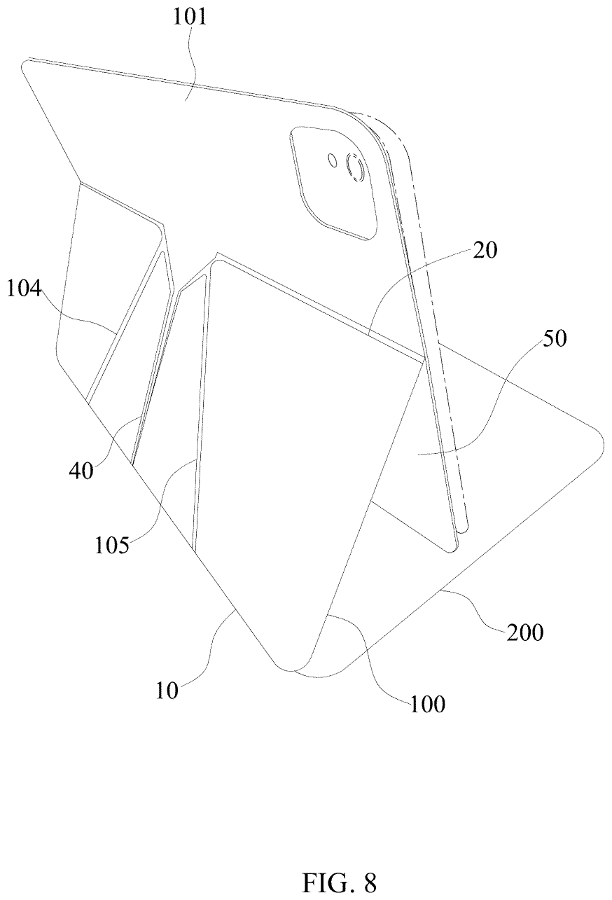

With reference to FIG. 8 for another embodiment of the present disclosure, after the mobile device protection and support frame is coupled to the mobile device, a side of the mobile device can be folded by the first primary flexible part 10 and the second primary flexible part 20 to abut against the second part 200. In this embodiment, the surface of the second part 200 is provided with an anti-slip material, so that when a side of the mobile device abuts the second part 200, the mobile device t will not slide and fall over.

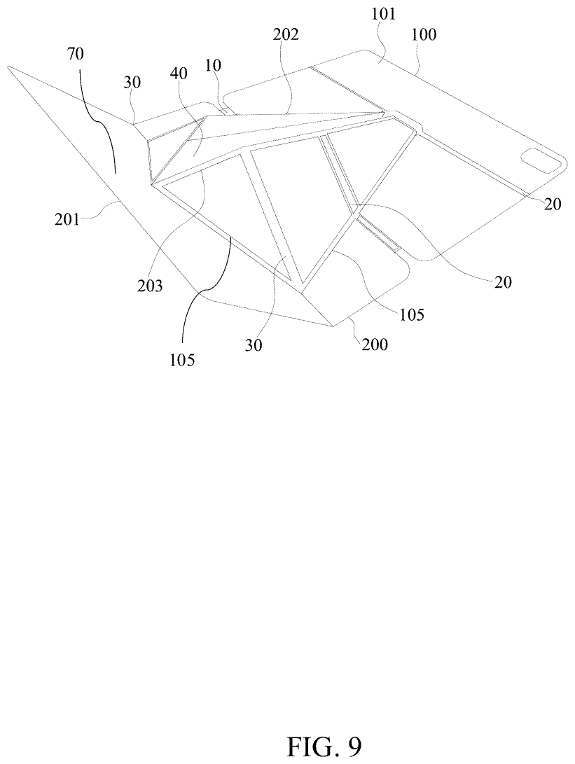

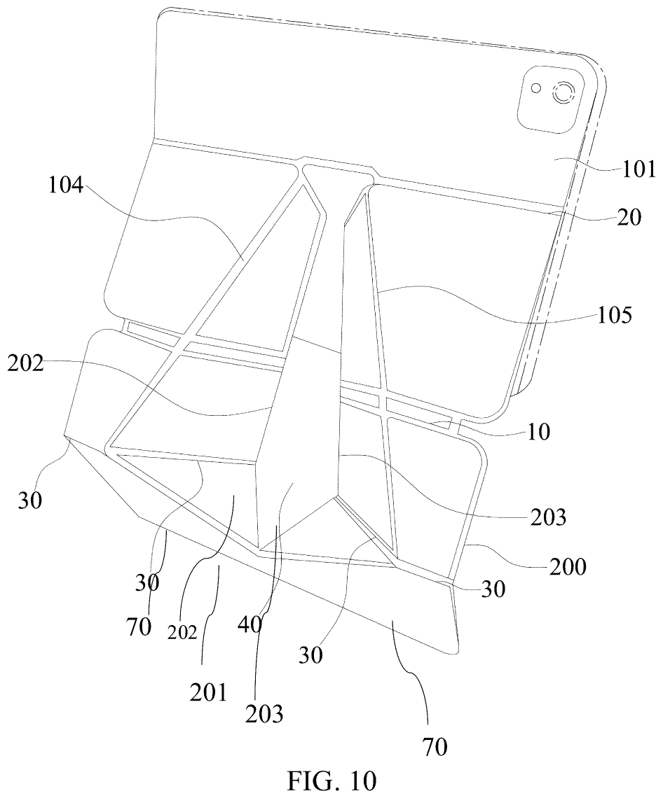

With reference to FIGS. 1 to 3, 9 and 10 for some embodiments of the present disclosure, the mobile device protection and support frame further includes a gap 40 spanning across the first primary flexible part 10 and the second primary flexible part 20, so that the first primary flexible part 10 and the second primary flexible part 20 are in a discontinuous form and disconnected to form a second free end 202 and a third free end 203. The mobile device protection and support frame of the present disclosure further includes a first secondary flexible part 104 and a second secondary flexible part 105 respectively and symmetrically located on two sides of the gap 40. In some embodiments, the first secondary flexible part 104 and the second secondary flexible part 105 span across the first primary flexible part 10 and the third primary flexible part 30. The second free end 202 and the third free end 203 can be folded towards either of the two sides of the first part 100 by the first secondary flexible part 104 and the second secondary flexible part 105 (as shown in FIGS. 9 and 10).

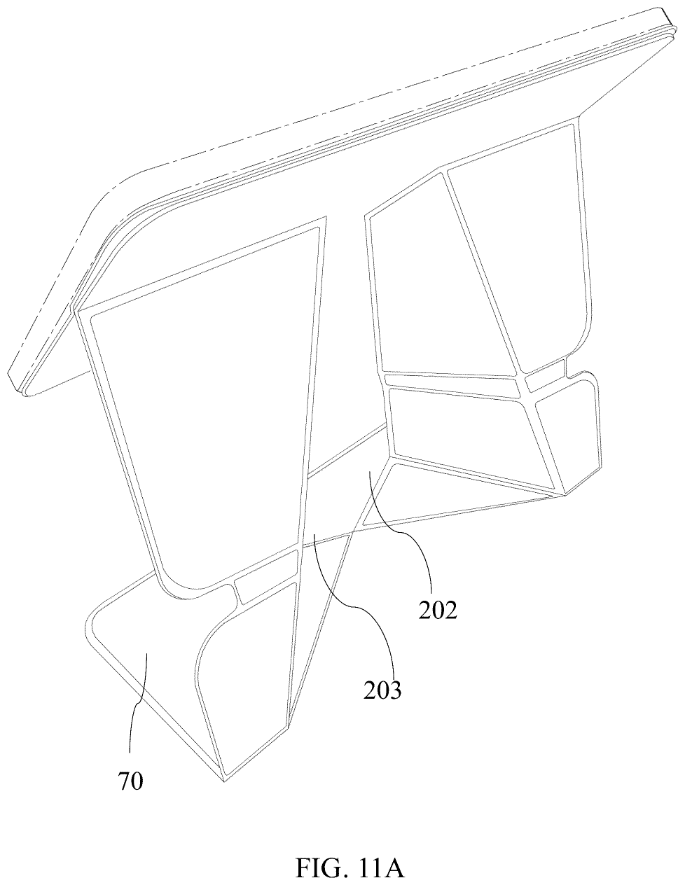

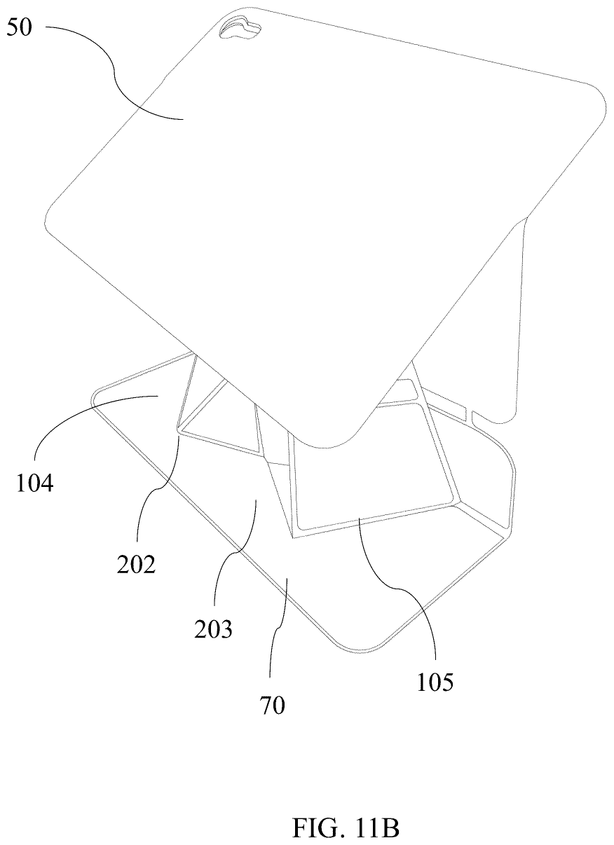

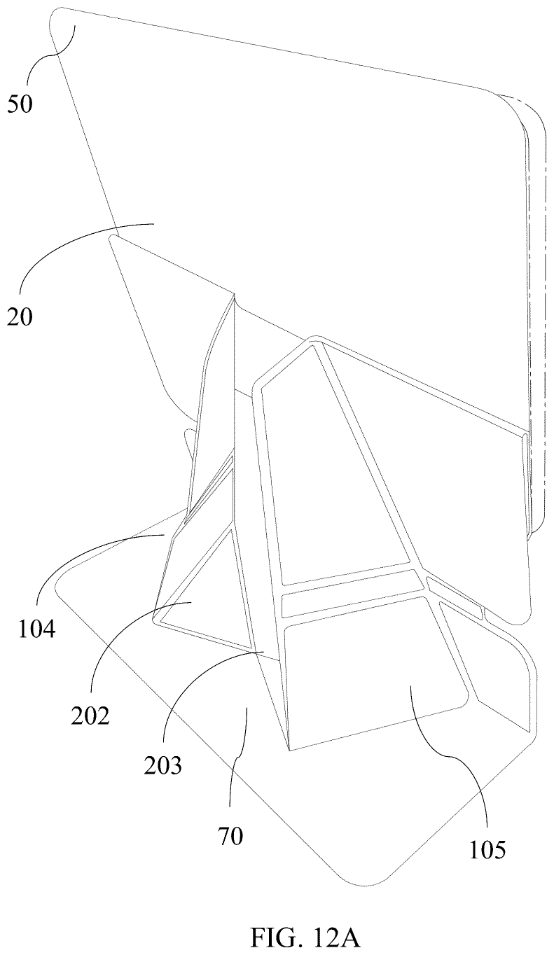

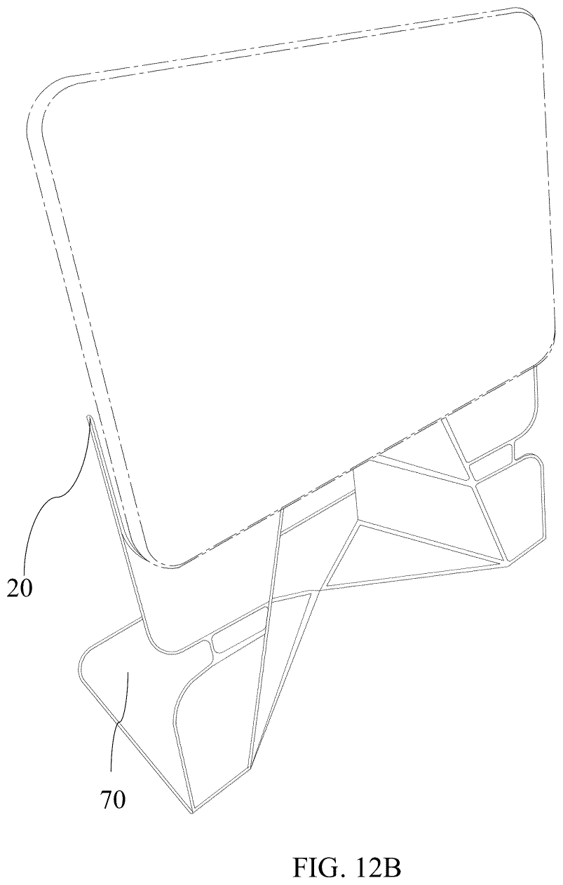

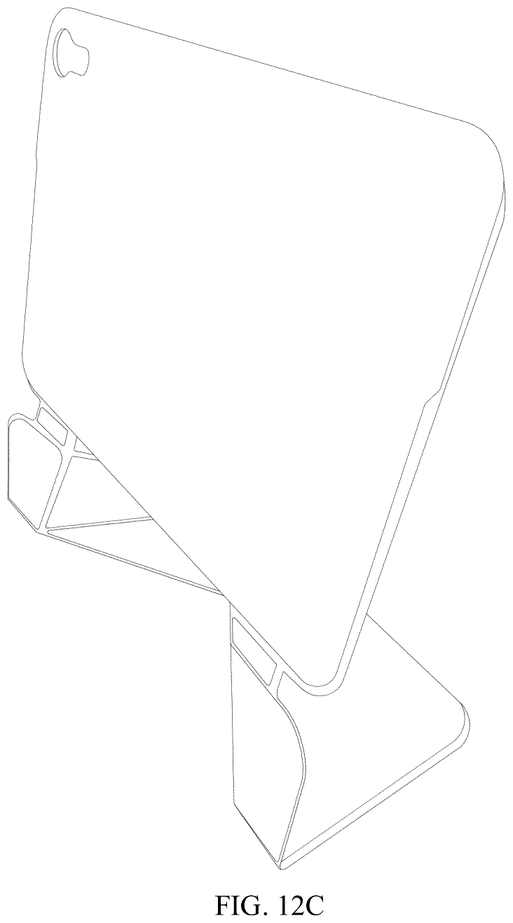

In FIGS. 9 and 10, the mobile device protection and support frame of the present disclosure further includes a distal part 70 located between the third primary flexible part 30 and the first free end 201, a part of the second free end 202 and the third free end 203 can be folded towards the distal part 70 by the first secondary flexible part 104 and the second secondary flexible part 105 and attached. As described above, the second free end 202 and the third free end 203 can be folded towards either of the two sides of the first part 100 by the first secondary flexible part 104 and the second secondary flexible part 105, so that the part of the second free end 202 and the third free end 203 can be folded towards the distal part 70 and attached by means of two methods as shown in FIGS. 11A and 11B and FIGS. 12A and 12B respectively. It is noteworthy that in the two aforementioned methods of folding and attaching towards the distal part 70, the users can adjust the bending of the second primary flexible part 20 to give the mobile device a different viewing angle. The difference between FIGS. 11A and 11B and FIGS. 12A and 12B is that the second free end 202 and the third free end 203 are folded towards different directions; and in FIGS. 12A and 12B, the fixed part 101 can be connected to a part of the first part 100.

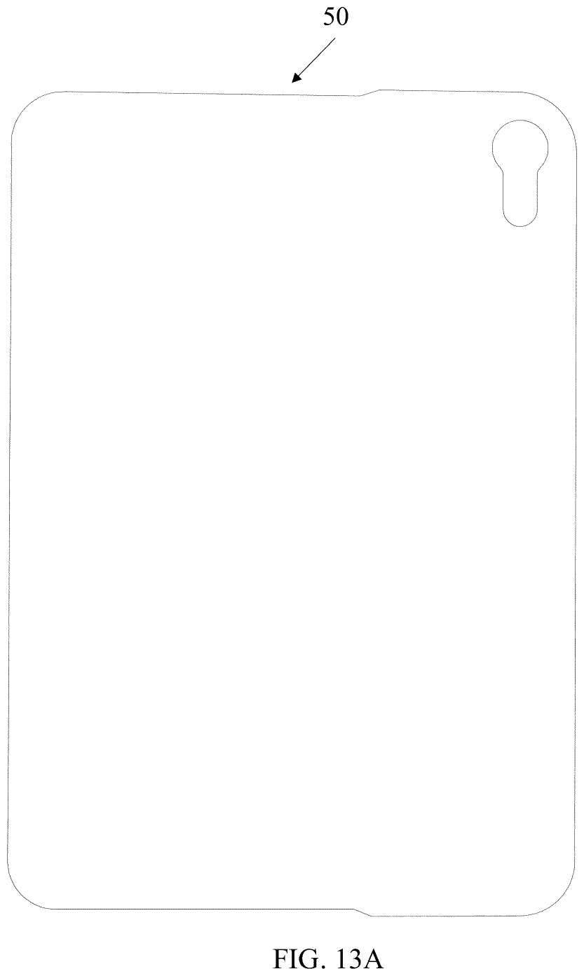

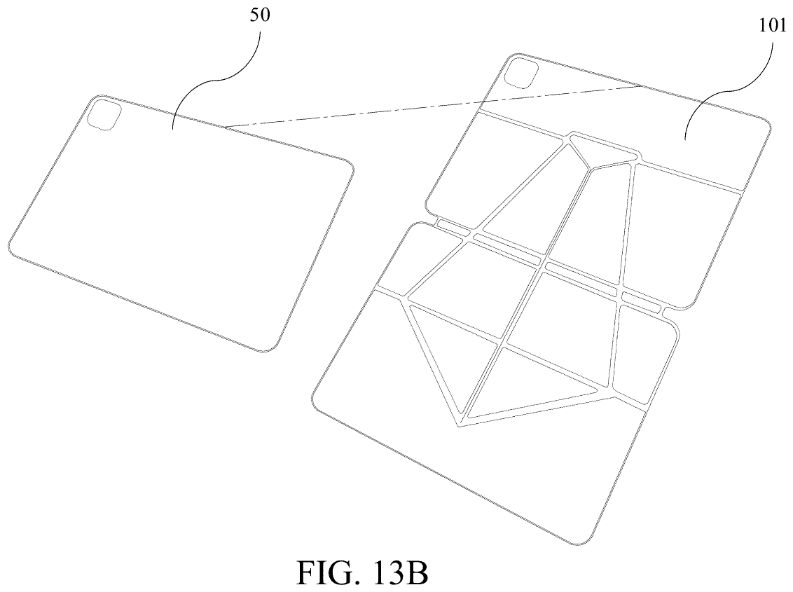

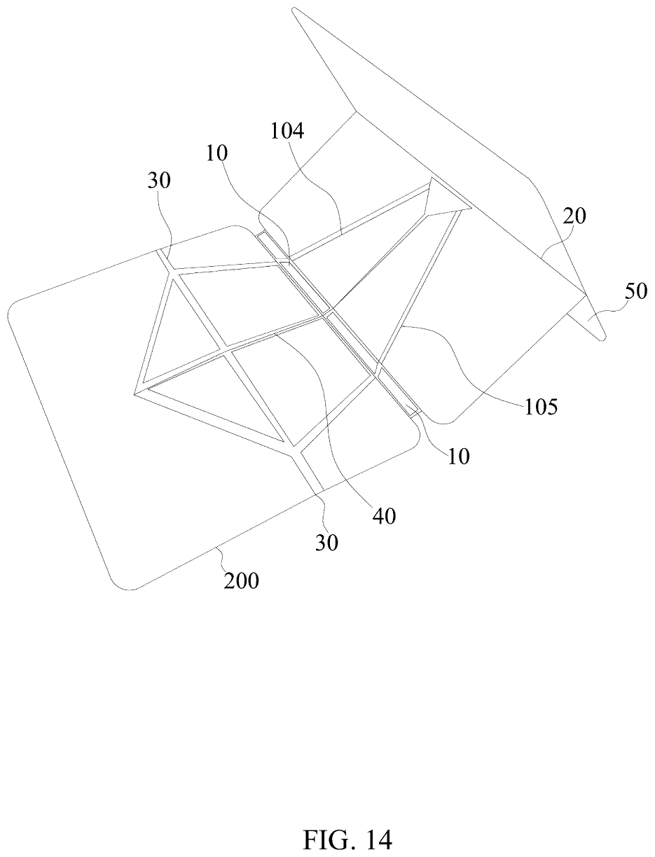

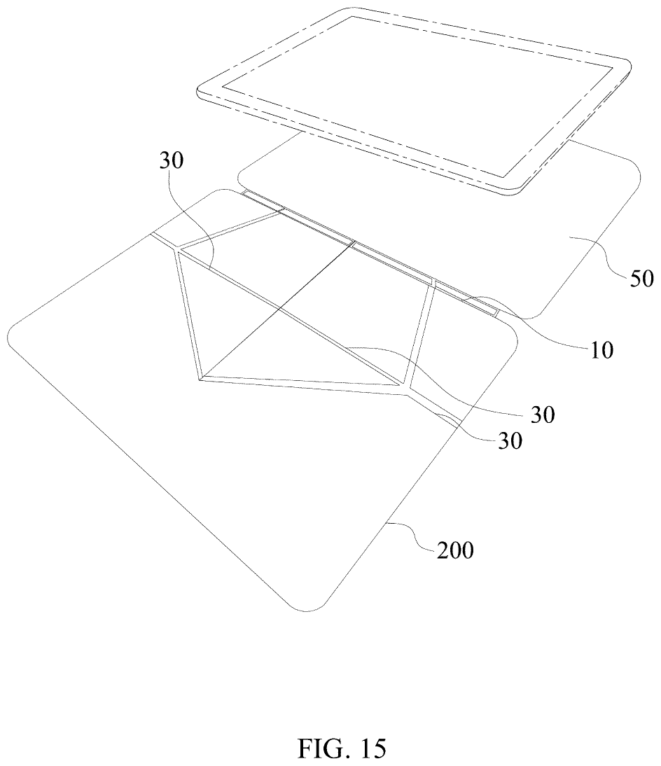

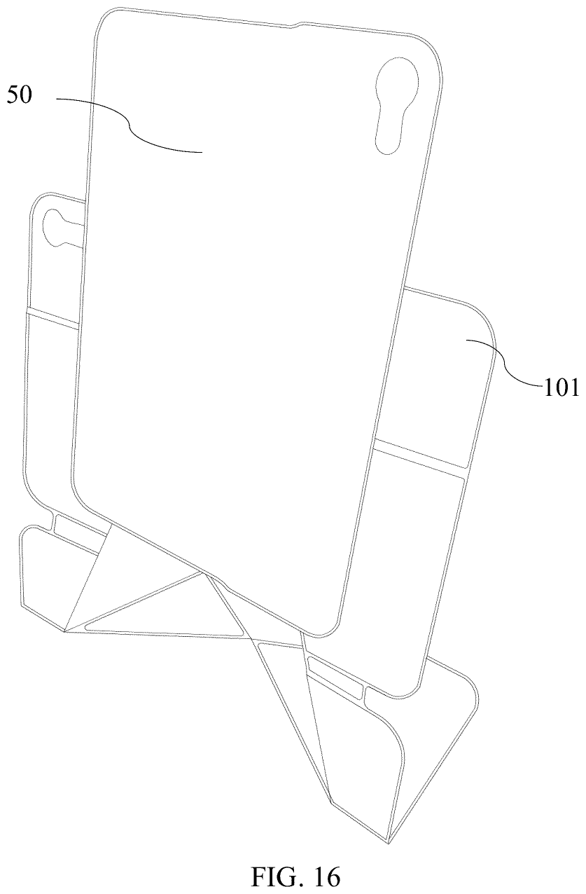

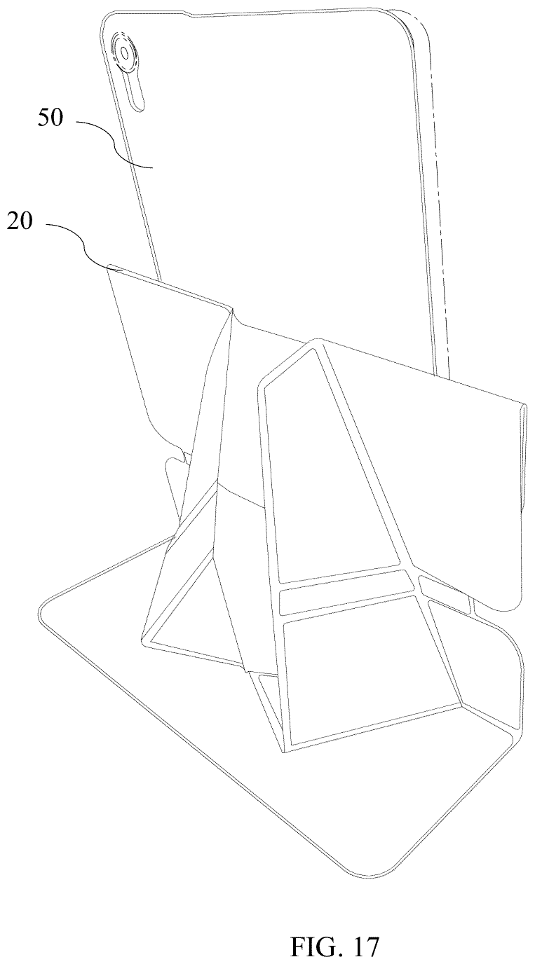

As described above, the present disclosure can be coupled to the mobile device by the coupling mechanism. For example, in some embodiments, the coupling mechanism is an adhesive, so that the fixed part 101 can be fixed to a part of the mobile device. In this way, the present disclosure is directly coupled to the mobile device. In some embodiments as shown in FIGS. 13A, 13B, 14 and 15, the coupling mechanism is a bottom plate 50, the fixed part 101 can be coupled to a part of the bottom plate 50, so that the first part 100 and the second part 200 can be folded relative to the bottom plate 50 by the first primary flexible part 10, the second primary flexible part 20 or the third primary flexible part 30. The bottom plate 50 is a sheet body, which is ferromagnetic, so that a part of the bottom plate 50 can be coupled to the fixed part 101 or the mobile device (as shown in FIG. 13B). The mobile device is also ferromagnetic, such that the present disclosure can be directly coupled to the mobile device through the bottom plate 50. In FIGS. 16 and 17, the bottom plate 50 can be coupled to the first part 100 of the present disclosure at any angles, so that users can select the way of browsing the mobile device in a horizontal or vertical manner.

In another embodiment, the fixed part 101 and a part of the bottom plate 50 are fixed to each other by a permanent fixing method, such that the first part 100 and the second part 200 can be folded relative to the bottom plate 50 by the second primary flexible part 20.

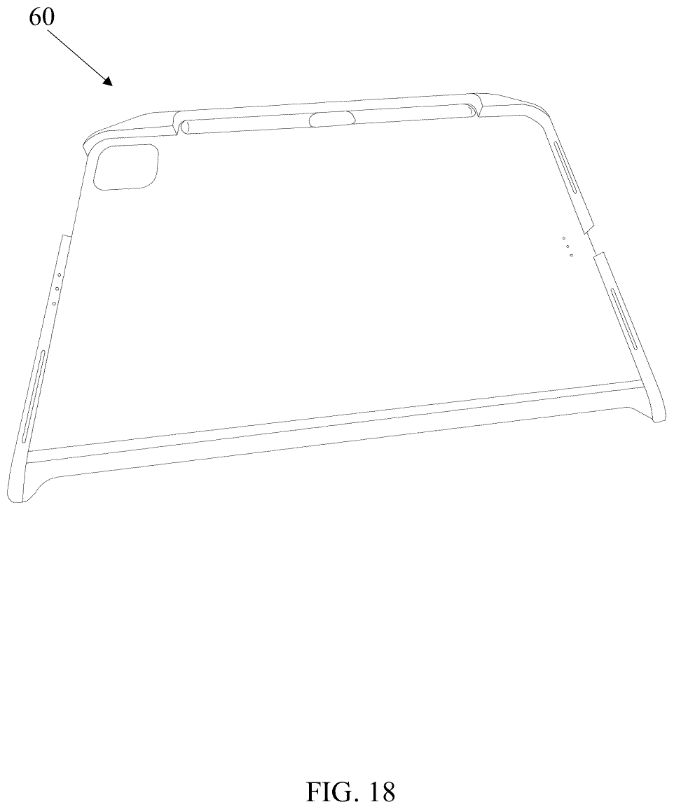

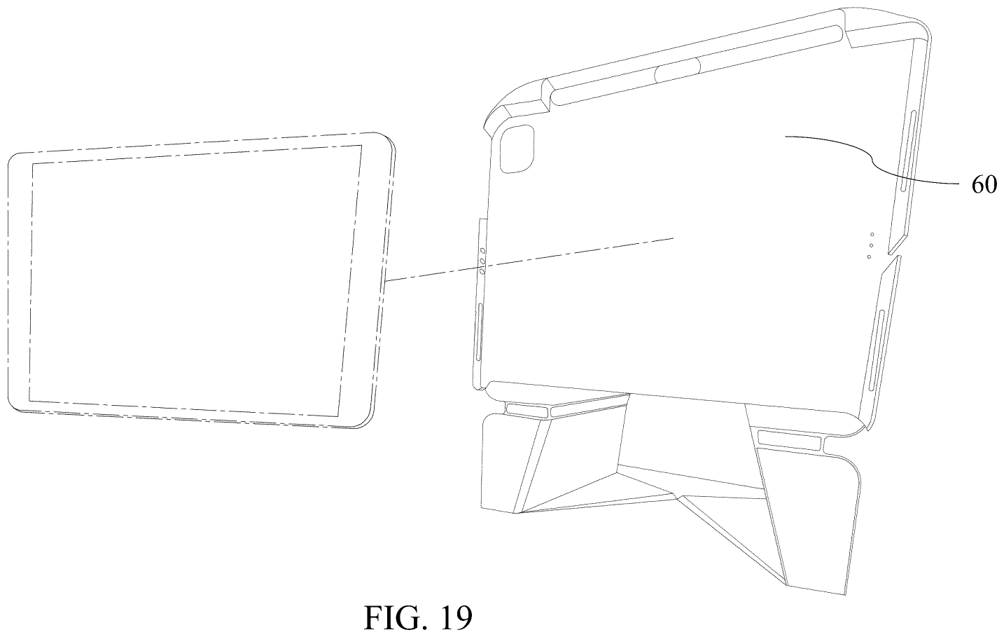

In FIGS. 18 and 19, the coupling mechanism is a snap-on back cover 60 with a size substantially the same as the mobile device and snapped to a side of the mobile device, the fixed part 101 is coupled to a part of the snap-on back cover 60, such that the first part 100 and the second part 200 can be folded relative to the snap-on back cover 60 by the first primary flexible part 10, the second primary flexible part 20 or the third primary flexible part 30. The snap-on back cover 60 is ferromagnetic, so that a part of the snap-on back cover 60 can be coupled to the fixed part 101 or the mobile device.

After the present disclosure is coupled to the mobile device by a coupling mechanism such as the bottom plate 50 or the snap-on back cover 60, the first free end 201 can be abutted between the bottom plate 50 and the first part 100, or between the snap-on back cover 60 and first part 100 by means of the first primary flexible part 10 or the third primary flexible part 30 as shown in FIG. 6. The bottom plate 50 or the snap-on back cover 60 or the first part 100 and the second part 200 can be respectively attached to two sides of the mobile device at the same time.

The mobile device protection and support frame of the present disclosure can be easily and conveniently used by users after folding, so that the frame can be placed according to the angle or direction required by the users for viewing or operating, thus greatly enhancing the convenience of use. Further, the present disclosure can be folded when not in use for convenient carry and storage.

The description above are only preferred embodiments of the present disclosure, and they are not intended to limit the scope of the present disclosure; therefore, equivalent changes and modification without departing from the spirit and scope of the present disclosure can be made and should be covered by the scope of the present disclosure.

What is claimed is:

1. A mobile device protection and support frame, which can be coupled to a mobile device by a coupling mechanism, comprising:
a first part, comprising a fixed part arranged on a side of the first part, thereby when the mobile device protection and support frame is coupled to the mobile device, the fixed part cannot be moved or folded relative to the mobile device; and
a second part, coupled to the first part by a first primary flexible part;
wherein, the first part further comprises a second primary flexible part spanning across the first part and disposed adjacent to the fixed part, such that a part of the first part and the second part can be folded relative to the fixed part;
wherein, the second part further comprises a third primary flexible part substantially parallel to the second primary flexible part; and
wherein, the first part is a sheet body including two sides, a first free end of the second part can be folded towards either of the two sides of the first part by the second primary flexible part or the third primary flexible part to abut against the first part.

2. The mobile device protection and support frame according to claim 1, further comprising a gap spanning across the first primary flexible part and the second primary flexible part, such that the first primary flexible part and the second primary flexible part are in a discontinuous form and disconnected to form a second free end and a third free end.

3. The mobile device protection and support frame according to claim 2, further comprising a first secondary flexible part and a second secondary flexible part respectively and symmetrically arranged on two sides of the gap.

4. The mobile device protection and support frame according to claim 3, wherein the second free end and the third free end are folded towards either of the two sides of the first part by the first secondary flexible part and the second secondary flexible part.

5. The mobile device protection and support frame according to claim 3, wherein the first secondary flexible part and the second secondary flexible part span across the first primary flexible part and the third primary flexible part.

6. The mobile device protection and support frame according to claim 1, wherein the first free end is folded towards either of the two sides of the first part by the second primary flexible part or the third primary flexible part to abut against the second primary flexible part.

7. The mobile device protection and support frame according to claim 1, wherein after the mobile device protection and support frame is coupled to the mobile device, a side of the mobile device is folded by the first primary flexible part and the second primary flexible part to abut against the second part.

8. The mobile device protection and support frame according to claim 3, further comprising a distal part located between the third primary flexible part and the first free end, a part of the second free end and the third free end can be folded towards the distal part by the first secondary flexible part and the second secondary flexible part and attached.

9. The mobile device protection and support frame according to claim 1, wherein the coupling mechanism is a snap-on back cover with a size substantially the same as the mobile device and snapped to a side of the mobile device, and the fixed part is coupled to a part of the snap-on back cover, such that the first part and the second part can be folded relative to the snap-on back cover by the first primary flexible part, the second primary flexible part or the third primary flexible part.

10. The mobile device protection and support frame according to claim 1, wherein the coupling mechanism a bottom plate, the fixed part and a part of the bottom plate are fixed to each other, such that the first part and the second part can be folded relative to the bottom plate by the second primary flexible part.

11. A mobile device protection and support frame, which can be coupled to a mobile device by a coupling mechanism, comprising:
a first part, comprising a fixed part arranged on a side of the first part, thereby when the mobile device protection and support frame is coupled to the mobile device, the fixed part cannot be moved or folded relative to the mobile device; and
a second part, coupled to the first part by a first primary flexible part;
wherein, the first part further comprises a second primary flexible part spanning across the first part and disposed adjacent to the fixed part, such that a part of the first part and the second part can be folded relative to the fixed part;
wherein, the first part is a sheet body including two sides, a first free end of the second part can be folded towards either of the two sides of the first part by the first primary flexible part to abut against the first part;
wherein, the mobile device protection and support frame further comprises a gap spanning across the first primary flexible part and the second primary flexible part, such that the first primary flexible part and the second primary flexible part are in a discontinuous form and disconnected to form a second free end and a third free end.

12. The mobile device protection and support frame according to claim 11, wherein the second part further comprises a third primary flexible part substantially parallel to the second primary flexible part, the first free end of the second part can be folded towards either of the two sides of the first part by the second primary flexible part or the third primary flexible part to abut against the first part.

13. The mobile device protection and support frame according to claim 12, further comprising a first secondary flexible part and a second secondary flexible part respectively and symmetrically arranged on two sides of the gap.

14. The mobile device protection and support frame according to claim 13, wherein the second free end and the third free end can be folded towards either of the two sides of the first part by the first secondary flexible part and the second secondary flexible part.

15. The mobile device protection and support frame according to claim 13, wherein the first secondary flexible part and the second secondary flexible part span across the first primary flexible part and the third primary flexible part.

16. The mobile device protection and support frame according to claim 12, wherein the first free end can be folded towards either of the two sides of the first part by the second primary flexible part or the third primary flexible part to abut against the second primary flexible part.

17. The mobile device protection and support frame according to claim 13, wherein after the mobile device protection and support frame is coupled to the mobile device, a side of the mobile device can be folded by the first primary flexible part and the second primary flexible part to abut against the second part.

18. The mobile device protection and support frame according to claim 12, further comprising a distal part located between the third primary flexible part and the first free end, and a first secondary flexible part and a second secondary flexible part respectively and symmetrically arranged on two sides of the gap, a part of the second free end and the third free end can be folded towards the distal part by the first secondary flexible part and the second secondary flexible part and attached.

19. The mobile device protection and support frame according to claim 12, wherein the coupling mechanism is a snap-on back cover with a size substantially the same as the mobile device and snapped to a side of the mobile device, and the fixed part is coupled to a part of the snap-on back cover, such that the first part and the second part can be folded relative to the snap-on back cover by the first primary flexible part, the second primary flexible part or the third primary flexible part.

20. The mobile device protection and support frame according to claim 12, wherein the coupling mechanism is a bottom plate, the fixed part and a part of the bottom plate are fixed to each other, such that the first part and the second part can be folded relative to the bottom plate by the second primary flexible part.
